(19) United States
(12) Patent Application Publication
(10) Pub. No.: US 2023/0237897 A1
(43) Pub. Date: Jul. 27, 2023

(54) METHOD OF REDUCING A FALSE TRIGGER ALARM ON A SECURITY ECOSYSTEM

(71) Applicant: Syber Sense IP Holdings, LLC, Millcreek, UT (US)

(72) Inventors: Lap Tak Tang, Hong Kong (CN); Barrett Morgan, Millcreek, UT (US)

(21) Appl. No.: 18/157,538

(22) Filed: Jan. 20, 2023

Related U.S. Application Data
(60) Provisional application No. 63/301,877, filed on Jan. 21, 2022.

(51) Int. Cl. G08B 29/18; G06V 20/52; G06V 10/774; G06V 10/778; G08B 31/00; G08B 13/196

(52) U.S. Cl. CPC G08B 29/18; G06V 20/52; G06V 10/774; G06V 10/7788; G08B 31/00; G08B 13/19602

(57) ABSTRACT

A method may include receiving an event message from a home security edge device, including image data. The method may include determining whether the image data represents a false trigger event based on inputting the image data into an artificial intelligence model and/or receiving a user input. The user input may be responsive to a presentation of the image data. If the image data represents the false trigger event, the method may include generating training data for retraining the artificial model. The training data may include a portion of the image data. The method may include updating a local dataset to include the training data and training the artificial intelligence model. The method may include transmitting the training data to a central database. If the image data does not represent a false trigger event, the method may include providing a security alert for display on one or more user devices.

### CROSS-REFERENCE TO RELATED APPLICATIONS

This application claims the benefit of U.S. Provisional Patent Application No. 63/301,877, filed Jan. 21, 2022, the entire contents of which are hereby incorporated by reference for all purposes in its entirety.

### BACKGROUND

Home security systems may include various devices for detecting objects and/or people. For example, home security systems may include: cameras, motion sensors, position sensors, gas sensors, liquid sensors, humidity sensors, and heat sensors. The device may send a signal to a hub when a disturbance is detected, e.g., when a person is detected in a house or a there is heat from a fire, the device may signal the hub. The hub may trigger an alarm based on the signal received from the device, however, the hub may trigger the alarm when there is no actual disturbance. This may result in users ignoring the alarms and not taking appropriate actions.

### SUMMARY

A method may include receiving an event message from a home security edge device. The event message may include image data. The method may also include determining whether the image data represents a false trigger event based on at least at one of inputting the image data into an artificial intelligence model or receiving a user input. The user input may be responsive to a presentation of the image data. The method may include, in accordance with determining that the image data represents the false trigger event, generating training data for retraining the artificial model. The training data may include at least a portion of the image data. The method may also include updating a local dataset to include the training data and training the artificial intelligence model using the training data. The method may also include transmitting the training data to a central database. In accordance with determining that the image data does not represent a false trigger event, the method may include providing a security alert for display on one or more user devices.

A computer-implemented method for determining a false trigger event may include receiving, from a computing device, a central dataset representing a plurality of historical false trigger events. The computer-implemented method may also include storing at least a portion of the central dataset to create a local dataset. The local dataset may include at least a portion of the plurality of historical false trigger events. The computer-implemented method may also include receiving image data that represents one or more objects. The computer-implemented method may include assigning a confidence score to each of the one or more objects based on comparing the one or more objects to the plurality of historical false trigger events stored in the local dataset. Each confidence score may represent a likelihood that a respective object of the one or more objects represents a current false trigger event. In accordance with determining that the confidence score of each of the one or more objects is greater than a predetermined threshold, the computer-implemented method may include updating the local dataset to include the one or more objects as one or more historical false trigger events. The computer-implemented method may also include transmitting the updated local dataset to the computing device. In accordance with determining that at least one confidence score of the one or more objects is lower than the predetermined threshold, the computer-implemented method may include providing a security alert for display on one or more user devices.

A home security system may include a home security edge device. The system may also a home security gateway device having one or more processors and non-transitory computer-readable memory. The memory may include instructions that, when executed by the one or more processors, cause the home security gateway device to perform operations. The operations may include receiving, from a computing device, a central dataset representing a plurality of historical false trigger events and storing at least a portion of the central dataset to create a local dataset. The local dataset may include at least a portion of the plurality of historical false trigger events. The operations may also include receiving image data that represents one or more objects and assigning a confidence score to each of the one or more objects. The confidence score may be based on comparing the one or more objects to the plurality of historical false trigger events stored in the local dataset, each confidence score representing a likelihood that a respective object of the one or more objects represents a current false trigger event. In accordance with determining that the confidence score of each of the one or more objects is greater than a predetermined threshold, the operations may include updating the local dataset to include the one or more objects as one or more historical false trigger events and transmitting the updated local dataset to the computing device. In accordance with determining that at least one confidence score of the one or more objects is lower than the predetermined threshold, the operations may include providing a security alert for display on one or more user devices.

A non-transitory computer-readable memory may include instructions that when executed by a processor, cause a computer system to perform operations including receiving, from a computing device, a central dataset representing a plurality of historical false trigger events. The operations may also include storing at least a portion of the central dataset to create a local dataset. The local dataset may include at least a portion of the plurality of historical false trigger events. The operations may also include receiving image data that represents one or more objects and assigning a confidence score to each of the one or more objects based on comparing the one or more objects to the plurality of historical false trigger events stored in the local dataset. Each confidence score may represent a likelihood that a respective object of the one or more objects represents a current false trigger event. In accordance with determining that the confidence score of each of the one or more objects is greater than a predetermined threshold, the operations may include updating the local dataset to include the one or more objects as one or more historical false trigger events and transmitting the updated local dataset to the computing device. In accordance with determining that at least one confidence score of the one or more objects is lower than the predetermined threshold, the operations may include providing a security alert for display on one or more user devices.

### BRIEF DESCRIPTION OF THE DRAWINGS

FIG. 1 illustrates a home security system including a home security gateway device and home security edge devices, according to certain embodiments.

FIG. 2 illustrates a process for determining if an event is a security event or a false trigger event, according to certain embodiments.

FIG. 3 shows a table of exemplary outcomes of a process for determining if an event is a security event or a false trigger event, according to certain embodiments.

FIG. 4 illustrates a workflow for updating a local dataset for use by an artificial intelligence model in a home security system, according to certain embodiments.

FIG. 5 illustrates a workflow for updating a central dataset for use by an artificial intelligence model in a home security system, according to certain embodiments.

FIG. 6 illustrates a diagram of a home security edge device, according to certain embodiments.

FIG. 7 illustrates a diagram of a home security gateway device, according to certain embodiments.

FIG. 8 illustrates a flowchart of a method for updating a local dataset included in a home security system, according to certain embodiments.

FIG. 9 illustrates a flowchart of a method of determining a false trigger event, according to certain embodiments.

FIG. 10 illustrates a block diagram of a home security system, according to certain embodiments.

FIG. 11 illustrates a workflow for training an artificial intelligence model, according to certain embodiments.

### DETAILED DESCRIPTION

Home security systems may be used to detect various motion events that may occur in the building and/or a dwelling of a user. The home security systems may send an alarm or an alert to the user when a motion event is detected. However, the home security system may send an alarm when no event has actually occurred (e.g., a false alarm). False alarms may impact a user's confidence in their home security system and may cause the user to ignore alarms which could impact their safety.

An example home security system may use artificial intelligence techniques to reduce the false alarms. For example, the home security system may use artificial intelligence techniques to identify and classify events, thereby reducing false alarms. The artificial intelligence techniques may include an artificial intelligence (AI) model. The AI model may be updated and/or trained based on the identified and classified events. The artificial intelligence techniques may be employed locally (e.g., on elements of the home security system) and/or may be employed in a server (e.g., in the cloud). Artificial intelligence techniques employed locally may have some drawbacks as compared with artificial intelligence techniques employed in the cloud (e.g., a limited dataset). However, artificial intelligence techniques employed solely in the cloud may have higher costs and take longer than artificial intelligence techniques deployed locally, as well as not being unique to a local environment.

This application relates to a smart home security system that includes components with one or more AIs that are faster and more effective than traditional systems, for example, at reducing false trigger events. The home security system may include a hub (e.g., a security gateway) that communicates with various detection devices (e.g., cameras, motions sensors, intercoms, door sensors, window sensors, smoke sensors, heat sensors, CO2 sensors, and/or doorbells). The detection devices may capture (e.g., record) data associated with a building or dwelling. For example, the detection devices may capture video, photos, audio, motion, smoke, heat, gas, chemicals, and/or data from any suitable sensor and/or detection device. The detection devices may be trained to analyze captured data to determine whether an event (e.g., a motion event) is a security event or a false trigger event. For example, these devices, which may include any suitable computing components, may use the artificial intelligence techniques, including training, aggregating, tuning and the like to analyze the captured data to determine if the event is a real motion event or if the event is a false alarm.

The captured data (e.g., captured data associated with a false trigger event) may be sent to the hub. The hub may use the captured data to update the AIs. For example, the AIs may be updated to improve the accuracy of detecting motion events and minimizing false triggers. The hub may include AI models that identify data associated with a false trigger. The data associated with a false alarm may be used to update the AI model of all of the devices associated with the hub. The hub may communicate with a database (e.g., a server and/or a cloud database) to send the data used to update the associated systems. For example, the data associated with the false trigger of a first system may be used to update a general model or dataset. The general model may then be used to update the AI model of a second system such that the same false trigger is not detected by either system in the future.

The general model may be used to update systems of the same type. For example, one or more first systems may be installed in apartments and one or more second systems may be installed in commercial buildings. As the first systems may be more likely to experience similar false triggers, the first systems may only update their AI model using a portion of the general model. Likewise, the second systems may experience similar false triggers, being different than those experienced by the first systems. Thus, the AI models in the second systems may be updated using a different portion of the general model.

The database may generate firmware with updated AIs that may be sent to the detection devices. The updated firmware may update the AIs used by the detection devices. The AIs may be updated based on where the home security system is installed and/or based on the user of the home security system. For example, the AI model may be updated to reduce false alarms for individual users. The system may continue to update the AI model based on further detected events to continue to improve and/or customize the detection devices for individual users.

The customized detection devices may lead to several technical improvements. For example, each device may experience a more efficient use of processing and memory because a smaller more finely tuned AI model is used, rather than having to run on a large process-intensive AI model. This can be important when running the AI model on the edge devices, beyond the panel. The customized AI model may also lead to network bandwidth savings as the system may be sending fewer false alarms to receiving devices. Furthermore, fewer false triggers may lead to a better user experience, greater safety and effectiveness of the system, and other benefits.

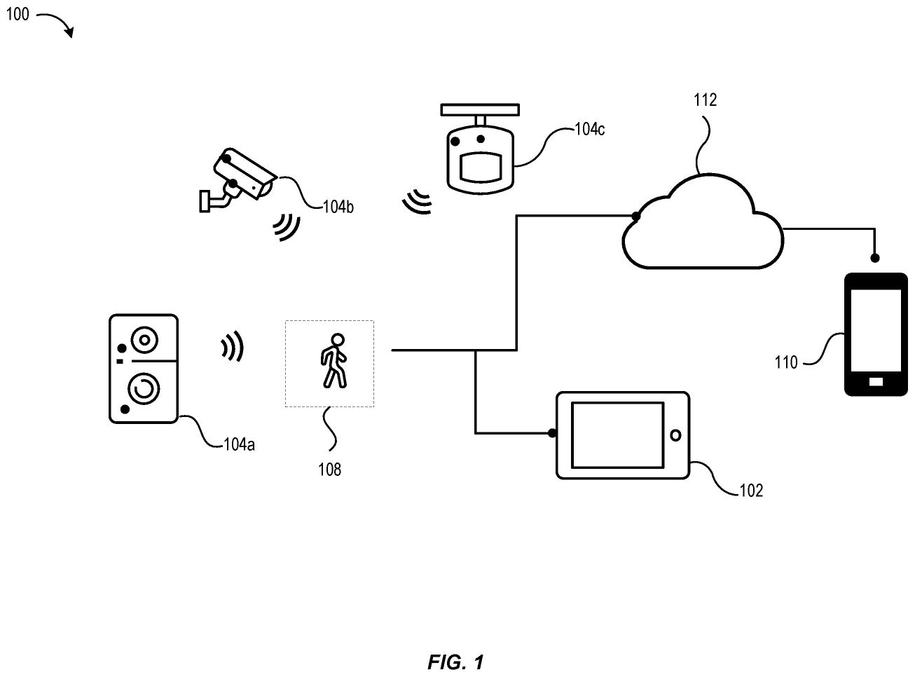

FIG. 1 illustrates a home security system 100 including a home security gateway device 102 and home security edge devices 104a-c, according to certain embodiments. The home security system 100 may also include a user device 110, and a security server 112. The security server 112 may be maintained by a cloud provider or other party responsible for maintaining communication for the home security system 100. The security server 112 may include one or more processors and non-transitory computer memory. The security server 112 may maintain a central dataset of historical false trigger events. In some embodiments, the security server 112 may be in communication with multiple home security systems, similar to the home security system 100. The home security system 100 may also be in communication with the user device 110, associated with the home security system 100. The user device 110 may include a mobile device, tablet, personal computer, or other suitable device.

The home security edge devices 104a-c may be configured to capture data associated with an event 108 in and around a home, building, or other such environment. The home security edge devices 104a-c may include a camera, a motion sensor, an intercom, a security panel, a gas sensor, a heat sensor, a smoke sensor, doorbells, and other suitable devices to capture event data. In some embodiments, one or more of the home security edge devices 104a-c may capture image data such as photos, video, or other suitable data. The home security edge devices 104a-c may also capture other sensor data including data associated with gas, heat, audio, and other suitable data. In some embodiments, one or more of the home security edge devices 104a-c may include one or more processors and non-transitory computer-readable memory. The non-transitory computer readable memory may include an artificial intelligence model (“AI”) such as the AI model described herein.

The home security gateway device 102 may include a security panel, tablet, personal computer, or other suitable device. The home security gateway device 102 may also include functionality to allow the home security gateway device 102 to communicate via one or more radio frequency protocols such as Wi-Fi, Bluetooth, Z-Wave, other sub-gigahertz frequencies, and other suitable protocols. This functionality may enable the home security gateway device to communicate with the home security edge devices 104a-c, the security server 112, and/or the user device 110. In some embodiments, the home security gateway device 102 may communicate with the user device 110 via the security server 112. In other embodiments, the home security gateway device 102 may communicate directly with the user devices 110 (e.g., via a local network, near-field communication protocol, cellular network, or the like). In all embodiments, the home security gateway device may communicate with the home security edge devices 104a-c.

The home security gateway device 102 may include one or more processors and a non-transitory computer-readable memory. The non-transitory computer readable memory may include an AI model such as the AI model described herein. In some embodiments, the home security system 100 includes the AI model stored in computer memory included in the home security edge devices 104a-c and the home security gateway device 102. In other embodiments, a first AI model is included in the home security edge devices 104a-c and a second AI model is included in the home security gateway device 102. In yet another embodiment, the AI model is included only on the home security edge devices 104a-c or the home security gateway device 102.

Similarly, a local dataset may be stored in the computer memory included in the home security edge devices 104a-c and/or the home security gateway device 102. The local dataset may include a central dataset of historical false trigger events, received from the security server 112. The local dataset may also include other false trigger events, not included in the central dataset. Each of the computer memories included in the home security edge device 104a-c and the home security gateway device 102 may have a unique local dataset, or the home security edge devices 104a-c and the home security gateway device 102 may share a local dataset. For example, in the case that each of the home security edge devices 104a-c include the AI, the home security gateway device 102 may maintain the local dataset and push the local dataset to each of the home security edge devices 104a-c. Alternatively, each of the home security edge devices 104a-c may access the local dataset stored at the home security gateway device 102 as needed, without storing the local dataset.

In another embodiment, the home security gateway device 102 may selectively push portions of the local dataset to the home security edge devices 104a-c. For example, the home security gateway device 102 may push a first portion of the local dataset to the home security edge devices 104a-b, and a second portion of the local dataset to the home security edge device 104c (e.g., based on the home security edge devices 104a-b being similar devices). Other configurations and possibilities would be recognized by someone of ordinary skill in the art.

In an example, the home security gateway device 102 may include the AI. The security server 112 may transmit the central dataset including the plurality of false trigger events to the home security gateway device 102. The home security gateway device 102 may then store at least a portion of the central dataset to create a local dataset. The local dataset may therefore include a portion of the plurality of false trigger events.

Continuing the example, the home security edge device 104b may include a camera and a motion detector. The motion detector may detect movement associated with an event 108 and cause the camera to capture image data associated with the event 108. The image data may represent one or more objects captured by the camera. For example, the home security edge device 104b may capture a clip of video, a photo, and/or a clip of audio associated with the event 108. The image data associated with the event 108 may be sent to the home security gateway device 102.

In some embodiments, the home security gateway device 102 may analyze the image data using an image analysis tool. The image analysis tool may employ techniques such as 3D pose estimation, image segmentation, object recognition, or other suitable techniques. In this way, the home security gateway device 102 may identify the one or more objects represented in the image data.

The home security gateway device 102 may then input the image data into the AI model. The AI model may compare the image data to the plurality of false trigger events included in the local dataset. The AI model may then assign a confidence score to each of the one or more objects represented in the image data. The confidence score may represent a likelihood that a respective object of the one or more objects matches a historical false trigger event and is therefore a current false trigger event.

Each confidence score may then be compared to a predetermined threshold (e.g., less than 50%, greater than 50%, 60%, 70%, 80%, 90%, and/or any other suitable threshold including more than 90%). In one case, each confidence score for each respective object may be above the predetermined threshold. The AI model may provide an output to the home security gateway device 102 that indicates the event 108 is a false trigger event. The home security gateway device 102 may then update the local dataset to include the one or more objects as one or more historical false trigger events. The home security gateway device 102 therefore may have a unique local dataset of historical false trigger events, allowing the home security gateway to identify false alarms unique to whatever environment the home security system 100 is monitoring.

The home security gateway device 102 may then transmit the updated local dataset to the security server 112. The security server 112 may then include the one or more historical false trigger events in the central dataset. In the case where the security server 112 is in communication with multiple home security systems, the central dataset may include historical false trigger events from each of the multiple home security systems. The central dataset may then be shared with each of the multiple home security systems at regular intervals and/or upon request. Thus, each of the home security systems may include historical false trigger events from all of the multiple home security systems.

In another case, at least one of the confidence scores may be below the predetermined threshold. Then, the home security gateway device 102 may provide a security alert for display. This may include transmitting the security alert to the user device 110 via the security server 112, transmitting the security alert to the user device 110 directly, and/or causing the security alert to be displayed on a display included in the home security gateway device 102. The security alert may include all or some of the image data, sound data, or any other suitable type of data. Further, the security alert may cause the user device 110 and/or the home security gateway device 102 to prompt a user for input. For example, the user may cause an input that identifies the one or more objects as a false trigger event. The home security gateway device 102 may receive the input, directly from the display included in the home security gateway device 102 and/or from the user device 110. The home security gateway device 102 may then update the local dataset to include the one or more objects as one or more historical false trigger events. The home security gateway device 102 may then update the central dataset accordingly.

Although the preceding example includes the AI model in the home security gateway device 102, other configurations are considered. For example, each of the home security edge devices 104a-c may include an AI model and a local dataset. The home security edge devices 104a-c may receive the central dataset from the home security gateway device 102 and/or the security server 112. One would recognize many different possibilities and configurations.

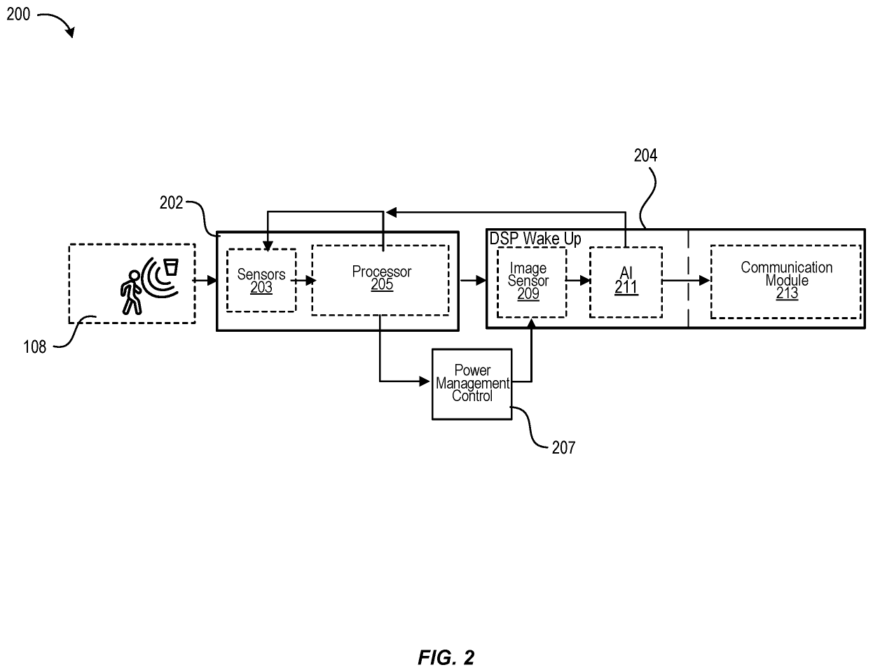

FIG. 2 illustrates a process 200 for determining if an event 108 is a security event or a false trigger event, according to certain embodiments. One or more of the steps of the process 200 for may be executed with one or more home security edge devices, such as the home security edge devices 104a-c in FIG. 1, a home security gateway device such as the home security gateway device 102, and/or a combination of one or more home security edge devices and the home security gateway device.

At block 202, the process 200 may include detecting an event 108. Block 202 may represent a single device, such as a home security edge device, or a combination of devices. The event 108 may include a motion event. The event 108 may be detected using one or more the home security edge devices. The event 108 may be detected, for example, using one or more sensors 203 (e.g., sensors 203 that are part of the home security edge devices). In some embodiments, the event 108 may be detected using a digital passive infrared sensor (PIR sensor) and/or an analog PIR sensor. A processor 205 may include a microcontroller and receive data associated with the event 108 from sensors 203. The processor 205 may include a motion detection algorithm used to process the data received by the sensors 203. For example, the motion detection algorithm may be used to determine if there was motion. To do so, the motion detection algorithm may access a local dataset, such as the local dataset described in FIG. 1. In the case of block 202 representing a single device, such as a home security edge device, the home security edge device may therefore determine that a false trigger event has occurred.

In some embodiments, the process 200 may include communicating with a power management control 208 to wake up a system included either in the same device or a combination of devices (e.g., of one or more home security edge devices and the home security gateway device). In some embodiments, the processor 205 may send a signal to a power management control 207 that motion has been detected. The power management control 207 may send a signal that the system should enter an on-mode from a low power and/or a sleep mode.

In some embodiments, the power management control 207 may send the signal to an image sensor 209. The image sensor 209 may include a camera and be part of the same home security edge device as the sensors 203. At block 204, the process 200 may include the image sensor 209 beginning to gather image data such as photographs or video. In other embodiments, the image sensor 209 may be included in another home security edge device, separate from the sensors 203. The device including the sensors 203 may send the signal through a home security gateway device to a second home security edge device including the image sensor 209. Alternatively or in addition, the device may send the signal directly to the second home security edge device.

At block 210, the process 200 may include using artificial intelligence to determine if the event 108 is a false trigger event. After gathering the image data, still in block 204, the image data may be provided to an artificial intelligence model 211 (AI). The AI model 211 may compare the image data to a plurality of false trigger events included in a local dataset. The AI model 211 may then assign a confidence score to each of one or more objects represented in the image data. The confidence score may represent a likelihood that a respective object of the one or more objects matches a historical false trigger event and is therefore a current false trigger event.

Each confidence score may then be compared to a predetermined threshold (e.g., 90% or any other suitable threshold). In one case, each confidence score for each respective object may be above the predetermined threshold. The AI model 211 may provide an output that indicates the event 108 is a false trigger event. The output may then be provided to the processor 205, allowing the device, including the processor and the sensors 203, to be trained using the false trigger event. The AI model 211 may also be trained using the false trigger event.

If the event 108 is determined to not include a false trigger event, the block 206 may include transmitting a security alert associated with the event 108 via communications module 213. The security alert may be transmitted to a user device and/or a home security gateway device. This may include transmitting the security alert to the user device via a security server (such as the security server 112 in FIG. 1), transmitting the security alert to the user device directly, and/or causing the security alert to be displayed on a display included in the home security gateway device. The security alert may include all or some of the image data, sound data, or any other suitable type of data. Further, the security alert may cause the user device and/or the home security gateway device to prompt a user for input.

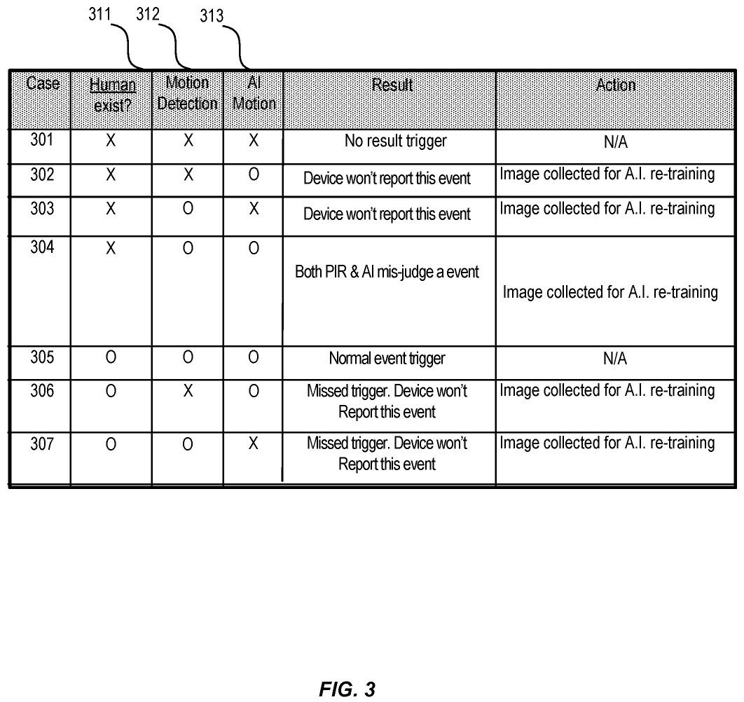

FIG. 3 shows a table 300 of exemplary outcomes of a process for determining if an event is a security event or a false trigger event, according to certain embodiments. The process may be similar to the process 200, described in FIG. 2. The table 300 is not exhaustive; other outcomes may be possible using the process shown here and/or other processes. The process may include a series of determinations by humans, sensors (such as sensors 203 in FIG. 2), and/or software components of a device (e.g., artificial intelligence models running on a home security edge device and/or a home security gateway device). In an embodiment, the determination may be made by two separate AI models—a first AI model represented in the column 312 and a second AI model represented in the column 313. The determinations may include whether an event is a false trigger event. In other words, the columns 311-313 may all represent outcomes of analysis by different parties (human and AI models) determining if an event is a false trigger event.

For example, a column 311 may include human input into a home security system (e.g., via a user device and/or a home security gateway). The human input may be in response to a security alert provided by a device as is described in FIG. 1. The human input may categorize the event as a false trigger event (or not). A column 312 may include a motion detection determination by a home security edge device such as the home security edge devices 104a-c in FIG. 1, and/or a PIR motion detector such as an analog or digital PIR motion detector. The motion detection determination may include detecting motion and determining whether or not the motion is false trigger event using a first artificial intelligence model (AI). A column 313 may include the results of a second AI model analysis at a home security gateway device. In case 301, all of the detections may be negative, and therefore no false trigger event is recorded, and therefore no action is taken.

In case 302, the first AI model may determine there is a false trigger (shown in the column 312), but the second AI model may determine that the event is a security event (shown in the column 313). In the column 311, the human may determine that there is a false trigger. Therefore, the second AI model may be incorrect, and the image associated with case 302 is collected to retrain the first AI.

In case 303, in column 312 the first AI model may determine the event is a security event, but the human (in column 311) and the second AI model (in column 313) may determine that the event is a false trigger event. Therefore, the first AI model may be incorrect, and the image associated with case 303 is collected to retrain the second AI model.

In case 304, both the first and second AI model may determine that the event is a security event, shown in columns 312 and 313 respectively. The human, however, may override these determinations, and flag the event as a false trigger event, as in column 311. Therefore, the image associated with the case 304 may be collected to retrain the first and second AI.

In case 305, the first AI model (in column 312), the second AI model (in column 313), and the human (in column 311) may determine that the event is a security event. Therefore, there is no need to retrain either the first or second AI model using images associated with the case 305.

In case 306, the first AI model may determine that the event is a false trigger event in column 312. The second AI model in column 313 and the human (in column 311) may determine, however, that the event is a security event. Because the first AI model determined there was a false trigger event, the device including the first AI model may not send a security alert. The image may therefore be collected and used to retrain the first AI model.

In case 307, the first AI model may determine that the event is a security event (shown in column 312), but the second AI model may determine that the event is a false trigger event (shown in column 313). The human may then determine that the event is a security event (shown in column 311). Because the second AI model determined that the event was a false trigger event, the device including the second AI model may not send a security alert. The image may therefore be collected and used to retrain the second AI model.

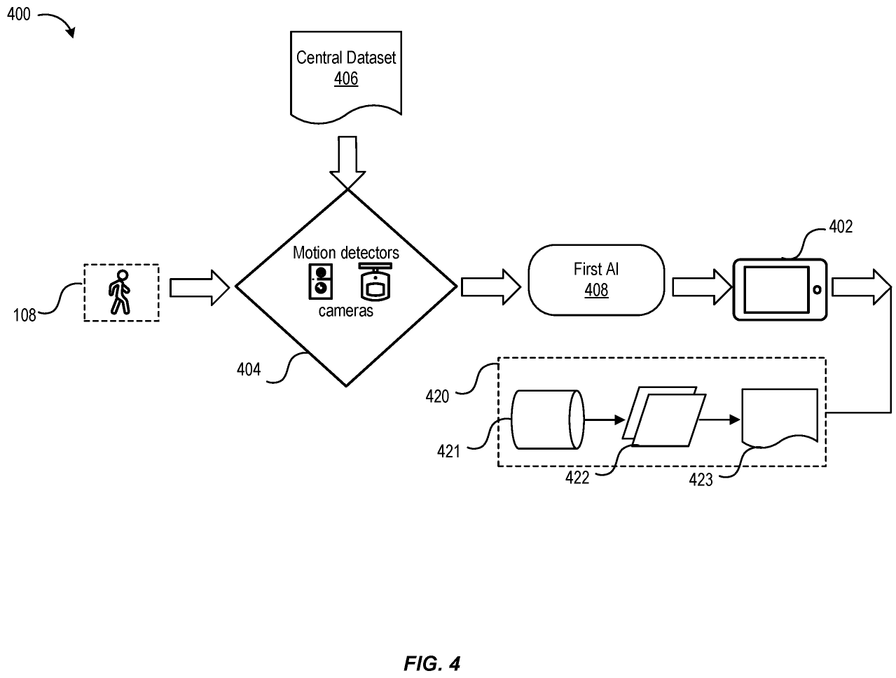

FIG. 4 illustrates a workflow for updating a local dataset 423 for use by an artificial intelligence model in a home security system 400, according to certain embodiments. The home security system 400 may be similar to the home security system 100 in FIG. 1. Therefore, the home security system 400 may include one or more home security edge devices similar to the home security edge devices 104a-c and a home security gateway device similar to the home security gateway device 102. As such, the devices and systems described below may include some or all of the functionality described in relation to FIG. 1.

The home security edge devices 404 may receive a central dataset 406. The home security edge devices may receive the central dataset 406 from a security server such as the security server 112 in FIG. 1. The central dataset 406 may include a plurality of historical false trigger events. The central dataset 406 may subsequently be stored on one or more of the home security edge devices 404. In some embodiments, the central dataset 406 may also be received by the home security gateway device 402.

The home security edge devices 404 may detect an event 108. The home security gateway device 402 may then receive an alert from the home security edge devices based on the event 108. The home security edge devices 404 may then provide data associated with the event 108 to a first artificial intelligence model (AI) 408. The first AI model 408 may be included in one or more of the home security edge devices 404.

The first AI model 408 may then provide an output to the home security gateway device 402. In some embodiments, the home security gateway device 402 may include a second AI model. The home security gateway device 402 may use the output from the first AI model 408 and/or the second AI model to determine whether the event is a security event or a false trigger event.

If it is determined that the event 108 is a false trigger event, the first AI model 408 and/or the second AI model may be updated locally via updating process 420. The updating process 420 may be performed by the home security gateway device 502 and/or one or more home security edge devices 504. Data 421 associated with the event 108 may be flagged as including a false trigger event. The data 421 may include image data as is described in relation to FIG. 1. The home security gateway device 402 may then include the data 421 in training data 422. The training data 422 may then be compiled into a local dataset 423. The local dataset 423 may also include some or all of the central dataset 406. The first AI model 408 and/or the second AI model may then be retrained using the local dataset 423. Although the central dataset 406 may be used when the system is first established, the local dataset 423 may become unique (e.g., tailored or otherwise unique with respect to the home security system 400) after some number of events like the event 108.

Retraining the first AI model 408 and/or the second AI model may include using the local dataset 423 to more accurately detect false trigger events. Mathematical transformation functions may be applied to the image data and/or objects thereof. The mathematical transformation functions may include affine transformations, rotating, shifting, mirroring, smoothing, contrast reduction or other such appropriate transformations. The first AI model 408 and the second AI model may then be trained with the local dataset 423 using stochastic learning with backpropagation or other suitable training methods. To minimize false positives, the first AI model 408 and the second AI model may be retrained using an iterative training algorithm. The iterative training algorithm may include creating a set of false positives (or here, actual security events) from the local dataset. The first AI model and/or the second AI model may repeat this iterative process until the number of false positives in a given training session is below a certain threshold.

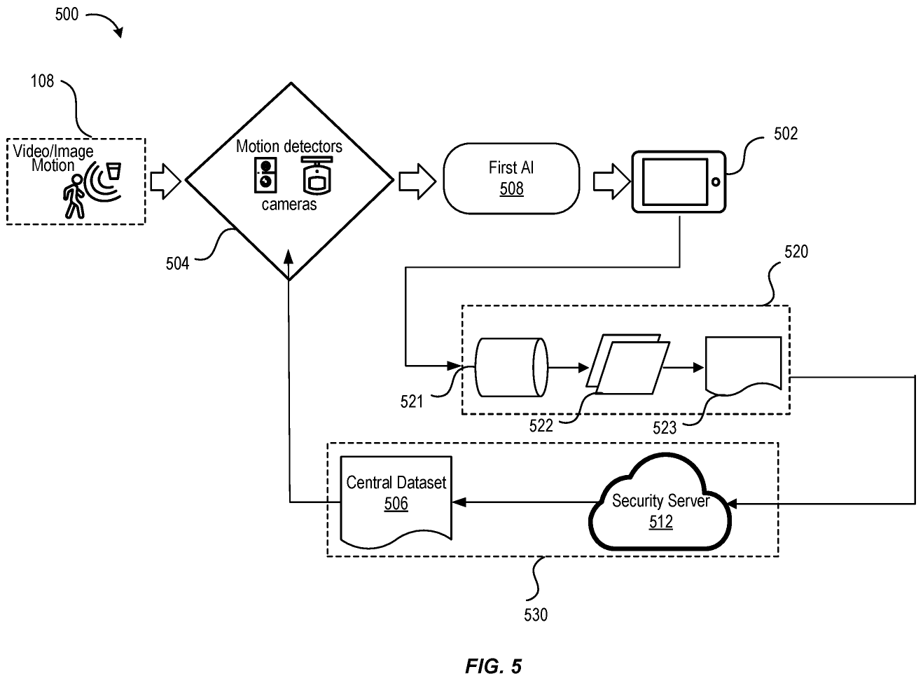

FIG. 5 illustrates a workflow for updating a central dataset 506 for use by an artificial intelligence model in a home security system 500, according to certain embodiments. The system may be similar to the home security system 400 shown in FIG. 4. Therefore, the home security system 500 may include one or more home security edge devices 504 similar to the home security edge devices 404 and a home security gateway device 502 similar to the home security gateway device 402. As such, the devices and systems described below may include some or all of the functionality described in relation to FIG. 4.

The home security edge devices 504 may receive a central dataset 506. The home security edge devices may receive the central dataset 506 from a security server 512 such as the security server 112 in FIG. 1. The central dataset 506 may include a plurality of historical false trigger events. The central dataset 506 may subsequently be stored on one or more of the home security edge devices 504. In some embodiments, the central dataset 506 may also be received by the home security gateway device 502.

The home security edge devices 504 may detect an event 108. The home security gateway device 502 may then receive an alert from the home security edge devices based on the event 108. The home security edge devices 504 may then provide data associated with the event 108 to a first artificial intelligence model (AI) 508. The first AI model 508 may be included in one or more of the home security edge devices 504.

The first AI model 508 may then provide an output to the home security gateway device 502. In some embodiments, the home security gateway device may include a second AI model. The home security gateway device 502 may use the output from the first AI model 508 and/or the second AI model to determine whether the event is a security event or a false trigger event.

If it is determined that the event 108 is a false trigger event, the first AI model 508 and/or the second AI model may be updated locally via updating process 520. The updating process 520 may be performed by the home security gateway device 502 and/or one or more home security edge devices 504. Data 521 associated with the event 108 may be flagged as including a false trigger event. The data 521 may include image data as is described in relation to FIG. 1. The home security gateway device 502 may then include the data 521 in training data 522. The training data 522 may then be compiled into a local dataset 523. The local dataset 523 may also include some or all of the central dataset 506. The first AI model 508 and/or the second AI model may then be retrained using the local dataset 523. Although the central dataset 506 may be used when the system is first established, the local dataset 523 may become unique after some number of events like the event 108.

After the updating process 520 is completed, the home security gateway device 502 may transmit some or all of the local dataset 523 to a security server 512. The security server 512 may be similar to the security server 112 in FIG. 1. For example, the home security gateway device 102 may send an over-the-air (OTA) request to the security server, requesting a firmware update. The OTA request may include the local dataset 523. The security server may then run a firmware generation process 530. The firmware generation process 530 may include compiling one or more updates required by the home security edge device 504 and/or the home security gateway device 502. The firmware generation process 530 may then include updating the central dataset 506 to include all or some of the local dataset 523.

The security server 512 may then transmit an OTA firmware update to the home security edge device 504, where any AI model included on the home security edge device 504 is updated to include the updated central dataset. Similarly, the security server 512 may then transmit an OTA firmware update to the home security gateway device 502. The updated central dataset may reduce the number of false triggers and improve accuracy of identifying events similar to the event 108. New firmware may be generated based on a false trigger event, a regular maintenance schedule, upon request from a user, and/or upon request from the security server 112. Thus, the performance of any AI model running on the home security system 500 may be continuously improved.

In various embodiments, individual users, buildings, and/or domiciles may have unique properties. The AI models included in a home security system 500 installed in any of these environments may be updated to take into account the unique properties. For example, a user's house may include a unique feature or object that causes the home security edge device 504 to mistakenly generate a security alert. The home security gateway device 502 may thereby generate firmware that customizes the AI model for the individual users. Although only one home security system 500 is shown in the workflow, any number of systems may be included.

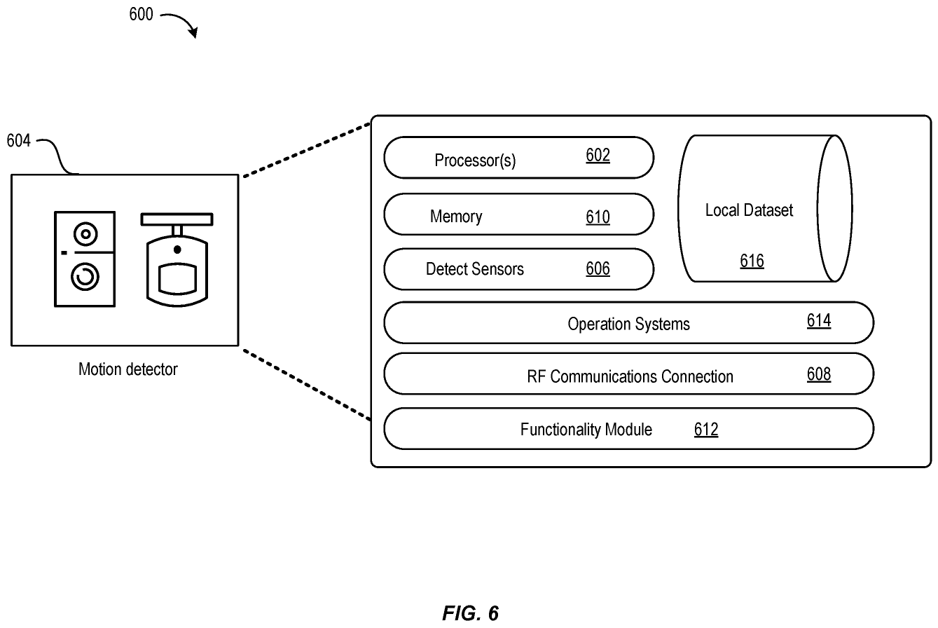

FIG. 6 illustrates a diagram 600 of a home security edge device 601, according to certain embodiments. The home security edge device 601 may be similar to one or more of the home security edge devices 104a-c in FIG. 1. The diagram 600 illustrates example components. The home security edge device 601 may include all or some of the components or may include other components not shown. The home security edge device 601 may include a processor 602, memory 610, and sensors 606. An operating system 614 may manage the processor 602, the memory 610, as well as any hardware, and/or firmware included in the home security edge device 604. For example, the operating system 614 may schedule various tasks and/or allocate processing power for different tasks. The home security edge device 604 may also include an RF communication connection device 608. The RF communication connection device 608 may be used to communicate with a wireless router, a user device, a server, and/or other computer devices via Wi-Fi, Bluetooth, Z-Wave, or other suitable communication protocols.

The sensors 606 may detect and/or capture data may capture image data such as photos, video, or other image data. The sensors 606 may also capture other sensor data including data associated with gas, heat, audio, and other suitable data. In some embodiments, the home security edge device 604 may include all or some of these sensors 606.

The memory 610 may include non-transitory computer readable media. The memory 610 may also include computer readable instructions that cause the processor 602 to perform the processes and methods disclosed herein. Furthermore, the memory 610 may also include an artificial intelligence model and a local dataset 816. The local dataset 616 may be similar to the local dataset 523 in FIG. 5 and include one or more historical false trigger events. The local dataset 616 may also include a central dataset, received from a security server such as the security server 112 in FIG. 1.

A functionality module 612 may include a motion detector algorithm, which may be used to detect motion events, as is described in FIG. 2. The functionality module 612 may also include an image analysis tools. The image analysis tool may employ techniques such as 3D pose estimation, image segmentation, object recognition, or other suitable techniques. In this way, the home security edge device 604 may identify the one or more objects represented image data captured by sensors 606.

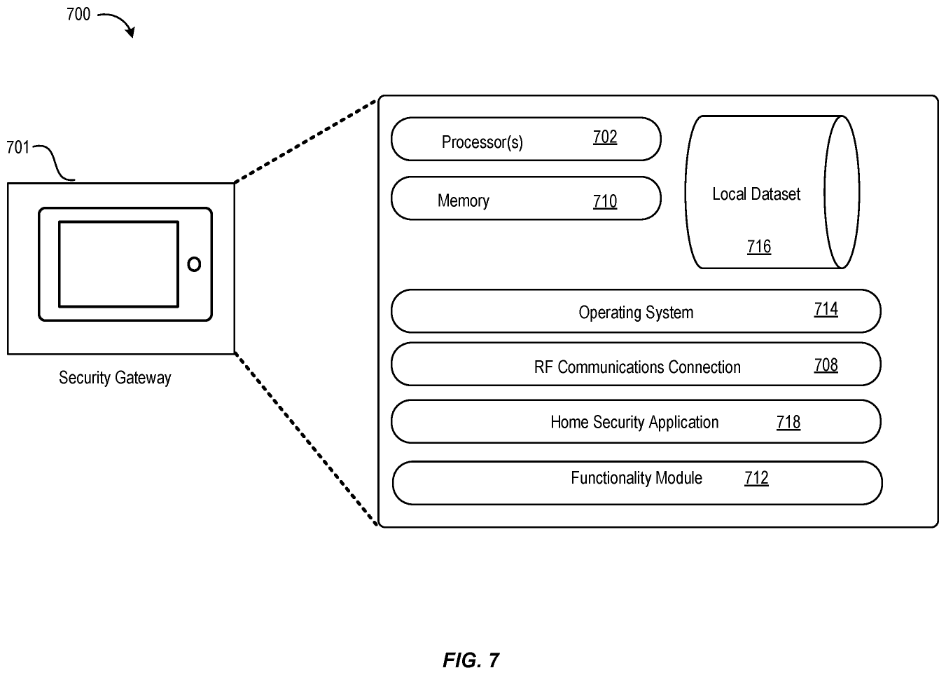

FIG. 7 illustrates a diagram 700 of a home security gateway device 701, according to certain embodiments. The home security gateway device 701 may include a processor 702, memory 710, and an artificial intelligence engine 706. The home security gateway device 701 may also include an RF communications connection device 708, a home security application 718, and an operating system 714. The processor 702 may implement one or more process and methods described herein. The operating system 714 may manage the processor 702, the memory 710, as well as any hardware, and/or firmware included in the home security gateway device 701. For example, the operating system 714 may schedule various tasks and/or allocate processing power for different tasks.

The RF communications connection device 708 may enable the home security gateway device 701 to communicate with a wireless router, a modem, a server, and/or home security edge devices 104a-c. The RF communication connection device 708 may communicate with a wireless router, a user device, a server, and/or other computer devices via Wi-Fi, Bluetooth, Z-Wave, or other suitable communication protocols.

The memory 610 may include non-transitory computer readable media. The memory 610 may also include computer readable instructions that cause the processor 602 to perform the processes and methods disclosed herein. For example, the computer readable instructions may enable the home security gateway device 701 to perform the updating process 420 in FIG. 4. Furthermore, the memory 710 may also include an artificial intelligence model and a local dataset 716. The local dataset 716 may be similar to the local dataset 523 in FIG. 5 and include one or more historical false trigger events. The local dataset 716 may also include a central dataset, received from a security server such as the security server 112 in FIG. 1.

The functionality module 712 may include system application protocols for the data associated with security events. The functionality module 712 may be similar to the functionality module 612 in FIG. 6, and include similar functionality and features. The functionality module 712 may also include a speaker or other audio device, as well as any necessary software to generate auditory alerts. The functionality module 712 may also include I/O hardware and software, a display, and other suitable functionality.

The home security application 718 may enable the home security gateway device 701 to manage home security edge devices such as the home security edge devices 104a-c in FIG. 1. The home security application 718 may also communicate with a security server such as the security server 112 in FIG. 1. Further, the home security application 718 may execute an alarm process in the case of a security event, and collect data associated with a false trigger event.

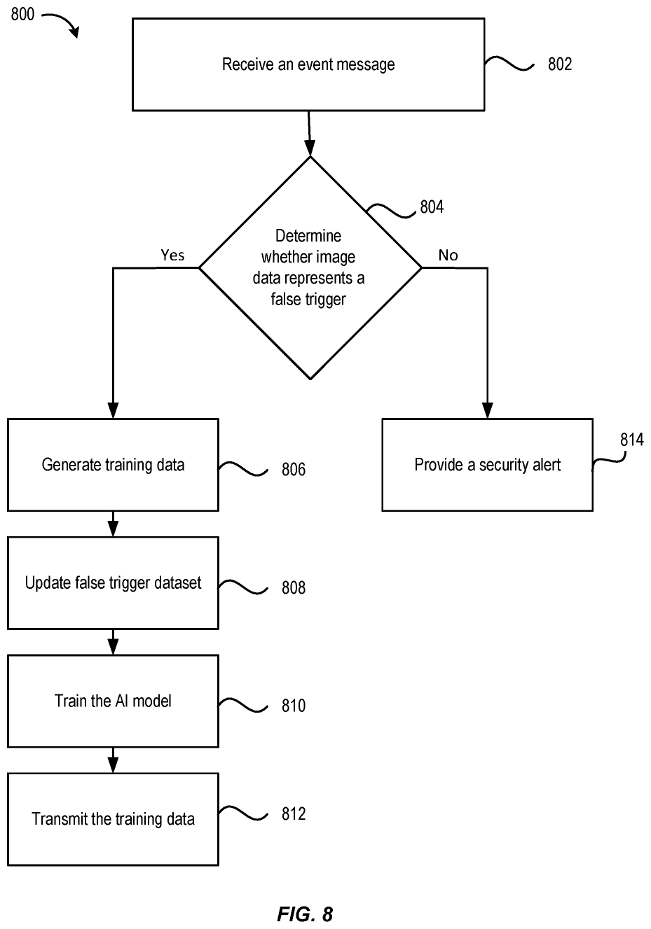

FIG. 8 illustrates a flowchart of a method 800 for updating a local dataset included in a home security system, according to certain embodiments. The method 800 may be performed by any of the systems included herein. For example, the method 800 may be performed by the home security system 100, described in FIG. 1. At block 802, the method 800 may include receiving an event message from a home security edge device. The home security edge device may be similar to one or more of the home security edge devices 104a-c in FIG. 1. The event message may include image data, gathered by one or more components included in the home security edge device. For example, a motion detector may detect movement associated with the event. A camera may then capture image data associated with the event. For example, the home security edge device may capture a clip of video, a photo, and/or a clip of audio associated with the motion event.

At block 804, the method 800 may include determining whether the image data represents a false trigger event, based on inputting the image data into an artificial intelligence model (AI) and/or receiving a user input. The AI model may compare the image data to a plurality of false trigger events included in a local dataset including a plurality of false trigger events. The AI model may then assign a confidence score to one or more objects represented in the image data. The confidence score may represent a likelihood that a respective object of the one or more objects matches a historical false trigger event and is therefore a current false trigger event. The confidence score may thus be used to determine if the event is a false trigger event.

The user input may be responsive to a presentation of the image data. The presentation may be on a home security gateway device such as the home security gateway device 102 in FIG. 1 and/or a user device such as the user device 110 in FIG. 1. The user device 110 may include a mobile device, tablet, personal computer, or other suitable device and be associated with the home security system.

In accordance with determining that the image data represents a false trigger event, at block 806, the method 800 includes generating training data for the AI. The training data may be based on the image data and may include at least part of the image data. The training data may also be flagged or labelled such that the false trigger is identified within the image data. At block 808, the method 800 includes updating a false trigger dataset to include the training data. The false trigger dataset may be similar to the local dataset 423, described in FIG. 4. The method may also include some or all of the update process 420 described in FIG. 4. At block 810, the method 800 may include training the AI model using the training data. The AI model may therefore become customized to the environment in which it is installed, as the data from event(s) would be unique to the environment.

At block 812, the method 800 may include transmitting the training data to a central database. Transmitting the training data may include sending the training data to a security server such as the security server 512 in FIG. 5. The security server may then use the training data to update a central dataset as in the firmware generation process 530 described in FIG. 5. The training data may be transmitted as part of the local dataset, or the training data may be transmitted on its own.

In accordance with determining that the image data does not represent a false trigger event, at block 814, the method 800 may include providing a security alert for display. The security alert may be displayed on the one or more user devices. In some embodiments, the security alert may be displayed on the home security gateway device. The security alert may include all or some of the image data, sound data, or any other suitable type of data. Further, the security alert may cause the user device and/or the home security gateway device to prompt a user for input.

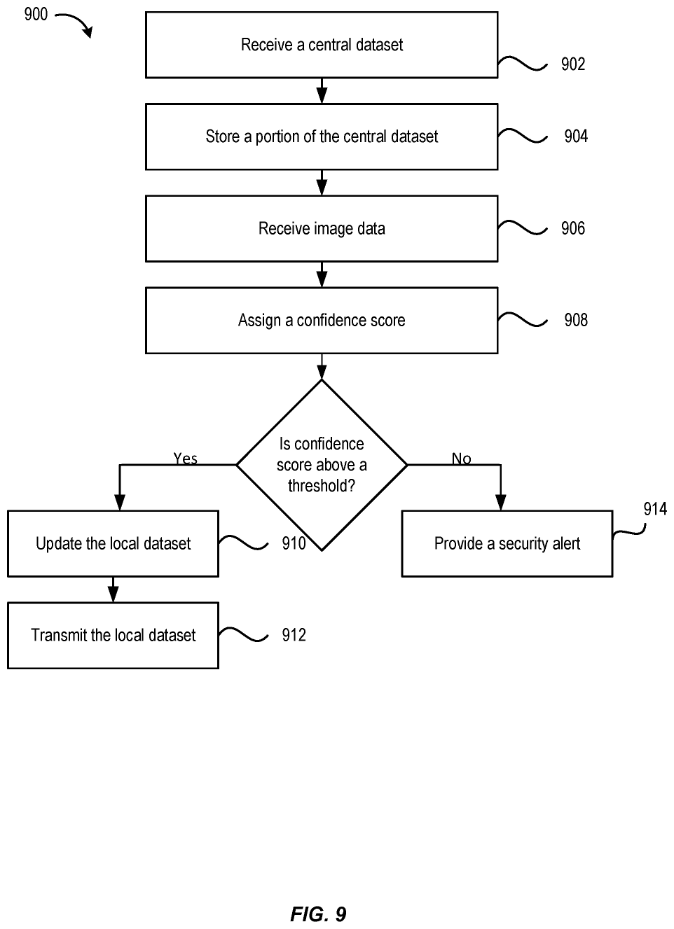

FIG. 9 illustrates a flowchart of a method 900 of determining a false trigger event, according to certain embodiments. The method 900 may be performed by any of the systems included herein. For example, the method 900 may be performed by the home security system 100, described in FIG. 1. At block 902, a central dataset is received from a computing device. The central dataset may represent a plurality of historical false trigger events. In some embodiments, the plurality of false trigger events may include images taken from photographs, video, or other suitable media. In some embodiments, the computing device may be similar to the security server 112 in FIG. 1. Alternatively or in addition, the computing device may be a home security gateway device similar to the home security gateway device 102 in FIG. 1. At block 904, the method 900 may include storing at least a portion of the central dataset. The central dataset may be used to create a local dataset. The local dataset may include the representations of the plurality of false trigger events.

At block 906, the method 900 may include receiving image data that represents one or more objects. The image data may be received from a home security edge device, such as one of the home security edge devices 104a-c in FIG. 1. The home security edge device may include a camera, a motion detector, and/or a microphone. Thus, the image data may include photos, video, or other suitable data types. In some embodiments, the one or more objects may be identified using an image analysis tool. The image analysis tool may employ techniques such as 3D pose estimation, image segmentation, object recognition, or other suitable techniques. In this way, the one or more objects represented in the image data may be identified.

At block 908, a confidence score may be assigned to each of the one of more objects. The confidence score may be assigned by an artificial intelligence model (AI) as described above. In some embodiments, the AI model may be included in one or more home security edge devices. The AI model may alternatively or additionally be included in the home security gateway device.

The AI model may compare the image data to the plurality of false trigger events included in the local dataset. The AI model may then assign a confidence score to each of the one or more objects represented in the image data. The confidence score may represent a likelihood that a respective object of the one or more objects matches a historical false trigger event and is therefore a current false trigger event.

Each confidence score may then be compared to a predetermined threshold (e.g., 90%). In accordance with determining that each confidence score for each respective object is greater than the predetermined threshold, block 910, the method 900 may include updating the local dataset using at least a portion of the image data. The local dataset may be updated to include the one or more objects which may be flagged as one or more historical false trigger events. In some embodiments, the AI model may be trained using the updated local dataset. Because the events that prompt the false trigger events are unique to the environment that the home security system is installed in, the updated local dataset may include a unique, customized dataset and therefore a personalized AI.

At block 912, the method 900 may include transmitting the local dataset to the computing device. In some embodiments, the local dataset may prompt the computing device to update the central dataset. The computing device may be in communication with multiple home security systems, each with its own local dataset. Thus, the central dataset may be constantly growing to include false trigger events from multiple home security systems (and thereby, environments). The central dataset may also be distributed to a plurality of home security gateway devices, each associated system may therefore have access to each system's dataset of false trigger events.

In accordance with determining that the confidence score of at least one of the one or more objects is lower than the predetermined threshold, at block 914 the method 900 may include providing a security alert for display on one or more user devices. In some embodiments, the one or more user devices may include a home security gateway device, a mobile phone, a personal computer, or other such user device.

In some embodiments, providing the security alert may further include receiving a user input from at least one of the user devices. The input may identify at least one of the one or more objects as a current false trigger event. In other words, if the AI model mistakenly sends a security alert for false trigger event, a user may classify the event as a false trigger event. Based on the input, the local dataset may be updated to include the one or more objects as historical false trigger events. The local dataset may then be transmitted to the computing device and the central dataset may be updated.

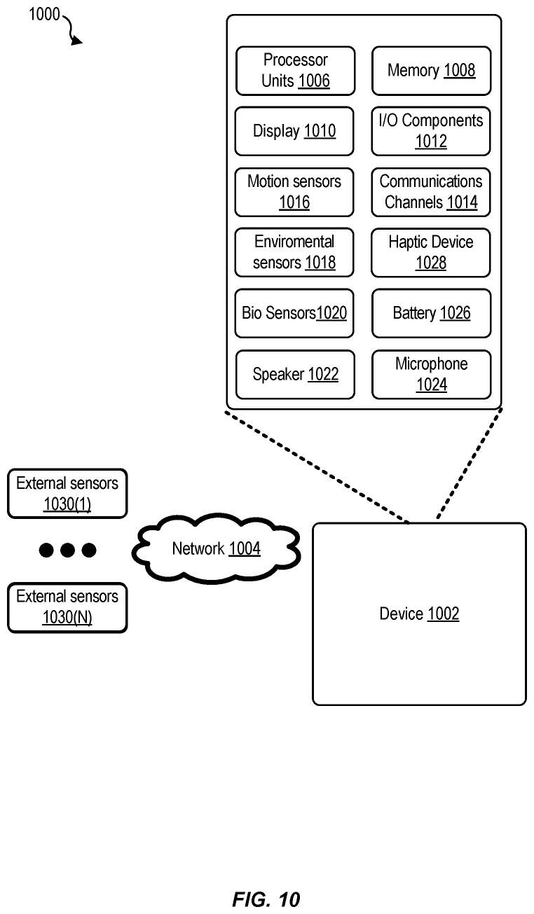

FIG. 10 illustrates a block diagram of a home security system 1000, according to certain embodiments. The security system 1000 may be or include the home security system 100. The security system 1000 may include a device 1002, which may include a home security gateway device and/or a home security edge device. The device 1002 may communicate with various other devices and systems via one or more networks 1004.

Examples described herein may take the form of, be incorporated in, or operate with a suitable electronic device such as, for example, a tablet device that may be mounted or secured within a home. The device may have a variety of functions, including, but not limited to: keeping time; monitoring a predefined area may maintaining communication with a plurality of onboard and external sensors; communicating (in a wired or wireless fashion) with other electronic devices, which may be different types of devices having different functionalities; providing alerts to a user, which may include audio, haptic, visual, and/or other sensory output, any or all of which may be synchronized with one another; visually depicting data on a display; gathering data from one or more sensors that may be used to initiate, control, or modify operations of the device; determining a location of a touch on a surface of the device and/or an amount of force exerted on the device, and using either or both as input; accepting voice input to control one or more functions; accepting tactile input to control one or more functions; and so on.

As shown in FIG. 10, the device 1002 (e.g., the home security gateway device 102 and/or the home security edge devices 104a-c) includes one or more processor units 1006 that are configured to access a memory 1008 having instructions stored thereon. The processor units 1006 of FIG. 10 may be implemented as any electronic device capable of processing, receiving, or transmitting data or instructions. For example, the processor units 1006 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 1008 may include removable and/or non-removable elements, both of which are examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 1008 is an example of non-transitory computer storage media. Additional types of computer storage media that may be present in the device 1002 may include, but are not limited to, phase-change RAM (PRAM), static random-access memory (SRAM), dynamic random-access memory (DRAM), random-access memory (RAM), read-only memory (ROM), electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that may be used to store the desired information and that may be accessed by the device 1002. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

In addition to storing computer-executable instructions, the memory 1008 may be configured to store historical sensor profiles. A historical sensor data profile may identify, for a particular set of conditions, configuration settings for operating the sensors of the device 1002 and/or external sensors 1030 (e.g., arm, away, home, etc.). The external sensors 1030 may be or include home security edge devices such as the home security edge devices 104a-c in FIG. 1. For example, the external sensors 1030 may include cameras, motion sensors, intercoms, security panels, a gas sensor, a heat sensor, a smoke sensor, and/or doorbells. In some examples, the historical sensor data profile may be generated using historical data collected from other users a controlled or uncontrolled environment. Machine-learning techniques may be applied to the historical data to build the profiles. In some examples, the profiles may be user-defined.

The instructions or computer programs may be configured to perform one or more of the operations or functions described with respect to the device 1002. For example, the instructions may be configured to control or coordinate the operation of the various components of the device. Such components include, but are not limited to, display 1010, one or more input/output (I/O) components 1012, one or more communication channels 1014, one or more motion sensors 1013, one or more environmental sensors 1018, one or more bio sensors 1020, a speaker 1022, microphone 1024, a battery 1026, and/or one or more haptic feedback devices 1028.

The display 1010 may be configured to display information via one or more graphical user interfaces and may also function as an input component, e.g., as a touchscreen. Messages relating to the execution of exams may be presented at the display 1010 using the processor units 1006.

The I/O components 1012 may include a touchscreen display, as described, and may also include one or more physical buttons, knobs, and the like disposed at any suitable location with respect to a bezel of the device 1002. In some examples, the I/O components 1012 may be located on an edge of the device 1002.

The communication channels 1014 may include one or more antennas and/or one or more network radios to enable communication between the device 1002 and other electronic devices such as one or more external sensors 1030, other electronic devices such as a smartphone or tablet, other wearable electronic devices, external computing systems such as a desktop computer or network-connected server. In some examples, the communication channels 1014 may enable the device 1002 to pair with a primary device such as a smartphone. The pairing may be via Bluetooth or Bluetooth Low Energy (“BLE”), near-field communication (“NFC”), or other suitable network protocol, and may enable some persistent data sharing. For example, data from the device 1002 may be streamed and/or shared periodically with the smartphone, and the smartphone may process the data and/or share with a server. In some examples, the device 1002 may be configured to communicate directly with the server via any suitable network, e.g., the Internet, a cellular network, etc.

The sensors of the device 1002 may be generally organized into three categories including motion sensors 1013, environmental sensors 1018, and bio sensors 1020. As described herein, reference to “a sensor” or “sensors” may include one or more sensors from any one and/or more than one of the three categories of sensors. In some examples, the sensors may be implemented as hardware elements and/or in software.

Generally, the motion sensors 1013 may be configured to measure acceleration forces and rotational forces along three axes. Examples of motion sensors include accelerometers, gravity sensors, gyroscopes, rotational vector sensors, significant motion sensors, step counter sensor, Global Positioning System (GPS) sensors, and/or any other suitable sensors. Motion sensors may be useful for monitoring device movement, such as tilt, shake, rotation, or swing. The movement may be a reflection of direct user input, but it may also be a reflection of the physical environment in which the device is sitting. The motion sensors may monitor motion relative to the device's frame of reference or your application's frame of reference. The motion sensors may monitor motion relative to the world's frame of reference. Motion sensors by themselves are not typically used to monitor device position, but they may be used with other sensors, such as the geomagnetic field sensor, to determine a device's position relative to the world's frame of reference. The motion sensors 1013 may return multi-dimensional arrays of sensor values for each event when the sensor is active. For example, during a single sensor event the accelerometer may return acceleration force data for the three coordinate axes, and the gyroscope may return rate of rotation data for the three coordinate axes.

Generally, the environmental sensors 1018 may be configured to measure environmental parameters such as temperature and pressure, illumination, and humidity. The environmental sensors 1018 may also be configured to measure physical position of the device. Examples of environmental sensors 1018 may include barometers, photometers, thermometers, orientation sensors, magnetometers, Global Positioning System (GPS) sensors, and any other suitable sensor. The environmental sensors 1018 may be used to monitor relative ambient humidity, illuminance, ambient pressure, and ambient temperature near the device 1002. In some examples, the environmental sensors 1018 may return a multi-dimensional array of sensor values for each sensor event or may return a single sensor value for each data event. For example, the temperature in ° C. or the pressure in hPa. Also, unlike motion sensors 1013 and bio sensors 1020, which may require high-pass or low-pass filtering, the environmental sensors 1018 may not typically require any data filtering or data processing.

The environmental sensors 1018 may also be useful for determining a device's physical position in the world's frame of reference. For example, a geomagnetic field sensor may be used in combination with an accelerometer to determine the user device's 1002 position relative to the magnetic north pole. These sensors may also be used to determine the user device's 1002 orientation in some of frame of reference (e.g., within a software application). The geomagnetic field sensor and accelerometer may return multi-dimensional arrays of sensor values for each sensor event. For example, the geomagnetic field sensor may provide geomagnetic field strength values for each of the three coordinate axes during a single sensor event. Likewise, the accelerometer sensor may measure the acceleration applied to the device 1002 during a sensor event. The proximity sensor may provide a single value for each sensor event.

Generally, the bio sensors 1020 may be configured to measure biometric signals of a wearer of the device 1002 such as, for example, heartrate, blood oxygen levels, perspiration, skin temperature, etc. Examples of bio sensors 1020 may include a heart rate sensor (e.g., photoplethysmography (PPG) sensor, electrocardiogram (ECG) sensor, electroencephalography (EEG) sensor, etc.), pulse oximeter, moisture sensor, thermometer, and any other suitable sensor. The bio sensors 1020 may return multi-dimensional arrays of sensor values and/or may return single values, depending on the sensor.

The acoustical elements, e.g., the speaker 1022 and the microphone 1024 may share a port in housing of the device 1002 or may include dedicated ports. The speaker 1022 may include drive electronics or circuitry and may be configured to produce an audible sound or acoustic signal in response to a command or input. Similarly, the microphone 1024 may also include drive electronics or circuitry and is configured to receive an audible sound or acoustic signal in response to a command or input. The speaker 1022 and the microphone 1024 may be acoustically coupled to a port or opening in the case that allows acoustic energy to pass but may prevent the ingress of liquid and other debris.

The battery 1026 may include any suitable device to provide power to the device 1002. In some examples, the battery 1026 may be rechargeable or may be single use. In some examples, the battery 1026 may be configured for contactless (e.g., over the air) charging or near-field charging.

The haptic device 1028 may be configured to provide haptic feedback to a user of the device 1002. For example, alerts, instructions, and the like may be conveyed to the user using the speaker 1022, the display 1010, and/or the haptic device 1028.

The external sensors 1030(1)-1030(n) may be any suitable sensor such as the motion sensors 1013, environmental sensors 1018, and/or the bio sensors 1020 embodied in any suitable device. For example, the external sensors 1030 may be incorporated into other user devices, which may be single or multi-purpose. For example, a position sensor may be used to determine whether a door or window has been opened, a motion sensor may be used to determine whether there is movement in a space, light sensors, power sensors, liquid detection sensors, and the like may also be used to perform the customary functions. Any of the sensor data obtained from the external sensors 1030 may be used to implement the techniques described herein.

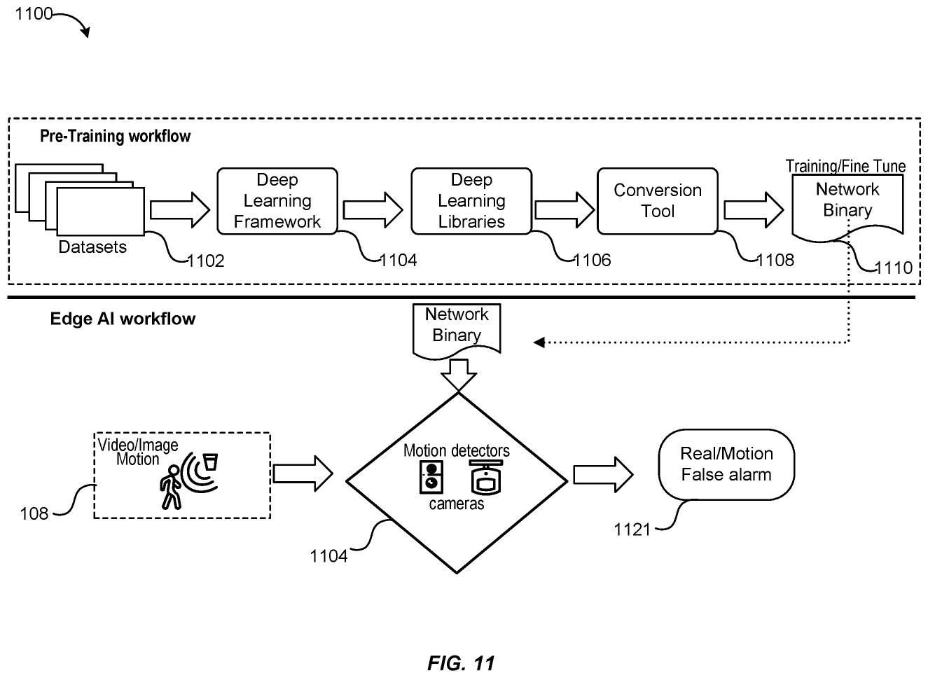

FIG. 11 illustrates a workflow 1100 for training an artificial intelligence model (AI) according to certain embodiments. The training may be or include a deep learning architecture. The deep learning architecture may generate training models related to specific tasks from large-scale data and make them suitable for specific applications. In various embodiments, the training may include using datasets 1102, deep learning framework 1104, deep learning libraries 1106, a conversion tool 1108, and/or network binary 1110.

The deep learning architecture may generate training models for AI model included in home security systems such as the home security system 100 in FIG. 1. The AI model may be included in home security edge devices (e.g., the home security edge devices 104a-c) and/or home security gateway devices (e.g., the home security gateway device 102). In some embodiments, the deep learning architecture may generate training models and/or datasets that may be used to train the home security edge devices to events such as motion events and determine if the event is a security or a false trigger event. The training models may additionally or alternatively be used to train the home security edge devices to output 1112 (e.g., output data to the home security gateway device 102). The output 1112 may be or include data associated with the real motion and/or the false alarm, alerts, and/or notifications. The training models may be used for iterative training of the deep learning architecture which may reduce false alarms.

For example, the training models may be or include the false alarms that have been identified by a user and/or the AIs (e.g., using artificial intelligence techniques). In some examples, the output from the training phase may be stored in a format suitable for ingestion and used by the home security edge devices.

Based on the disclosure and teachings provided herein, a person of ordinary skill in the art will appreciate other ways and/or methods to implement the various embodiments. The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

In the following, further examples are described to facilitate the understanding of the present disclosure.

Example 1. In this example, there is provided a method, including:
receiving an event message from a home security edge device, the event message including image data;
determining whether the image data represents a false trigger event based on at least at one of:
inputting the image data into an artificial intelligence model; or
receiving a user input responsive to a presentation of the image data;
in accordance with determining that the image data represents the false trigger event:
generating training data for training the artificial intelligence model based on the false trigger event, the training data including the image data;
updating a local dataset to include the training data;
training the artificial intelligence model using the training data; and
transmitting the training data to a central database; and
in accordance with determining that the image data does not represent a false trigger event, providing a security alert for display on one or more user devices.

Example 2. In this example, there is provided a method of example 1, further including transmitting the training data to a central database.

Example 3. In this example, there is provided a method of example 2, wherein the home security edge device includes at least one of a motion detector, a camera, and a microphone.

Example 4. In this example, there is provided a computer-implemented method for determining a false trigger event, the computer-implemented method including:
receiving, from a computing device, a central dataset representing a plurality of historical false trigger events;
storing at least a portion of the central dataset to create a local dataset including at least a portion of the plurality of historical false trigger events;
receiving image data that represents one or more objects;
assigning a confidence score to each of the one or more objects based on comparing the one or more objects to the plurality of historical false trigger events stored in the local dataset, each confidence score representing a likelihood that a respective object of the one or more objects represents a current false trigger event;
in accordance with determining that the confidence score of each of the one or more objects is greater than a predetermined threshold:
updating the local dataset to include the one or more objects as one or more historical false trigger events; and
transmitting the updated local dataset to the computing device; and
in accordance with determining that at least one confidence score of the one or more objects is lower than the predetermined threshold, providing a security alert for display on one or more user devices.

Example 5. In this example, there is provided a method of example 4, wherein in accordance with determining that at least one confidence score of the one or more objects is lower than the predetermined threshold, providing the security alert for display on one or more user devices further includes:
receiving, from at least one of the one or more user devices, a user input identifying the one or more objects as a current false trigger event;
updating the local dataset to include the one or more objects as one or more historical false trigger events; and
transmitting the local dataset to the computing device.

Example 6. In this example, there is provided a method of example 4, wherein the security alert includes at least a portion of the image data.

Example 7. In this example, there is provided a method of example 4, wherein the central dataset is distributed to a plurality of home security gateway devices.

Example 8. In this example, there is provided a method of example 4, wherein the one or more user devices comprise at least one of a home security gateway device, a mobile phone, and a personal computer.

Example 9. In this example, there is provided a method of example 4, wherein the one or more objects are identified in the image data by an image analysis tool.

Example 10. In this example, there is provided a system including:
a home security edge device; and
a home security gateway device including:
one or more processors; and
non-transitory computer-readable memory including instructions that when executed by the one or more processors, cause the home security gateway device to perform operations including:
   receiving, from a computing device, a central dataset representing a plurality of historical false trigger events;
   storing at least a portion of the central dataset to create a local dataset including at least a portion of the plurality of historical false trigger events;
   receiving image data that represents one or more objects;
   assigning a confidence score to each of the one or more objects based on comparing the one or more objects to the plurality of historical false trigger events stored in the local dataset, each confidence score representing a likelihood that a respective object of the one or more objects represents a current false trigger event;
   in accordance with determining that the confidence score of each of the one or more objects is greater than a predetermined threshold:
   updating the local dataset to include the one or more objects as one or more historical false trigger events; and
   transmitting the updated local dataset to the computing device; and
   in accordance with determining that at least one confidence score of the one or more objects is lower than the predetermined threshold, providing a security alert for display on one or more user devices.

Example 11. In this example, there is provided a system of example 10, wherein the operations further comprise:
receiving, from at least one of the one or more user devices, a user input identifying the one or more objects as a current false trigger event;
updating the local dataset to include the one or more objects as one or more historical false trigger events; and
transmitting the local dataset to the computing device.

Example 12. In this example, there is provided a system of example 10, wherein the security alert includes at least a portion of the image data.

Example 13. In this example, there is provided a system of example 10, wherein the central dataset is distributed to a plurality of home security gateway devices.

Example 14. In this example, there is provided a system of example 10, wherein the one or more objects are identified in the image data by an image analysis tool.

Example 15. In this example, there is provided a system of example 10, wherein the home security edge device includes at least one of a motion detector, a camera, and a microphone.

Example 16. In this example, there is provided a non-transitory computer-readable memory including instructions that, when executed by one or more processors of a computer system, causes the computer system to perform operations including:
receiving, from a computing device, a central dataset representing a plurality of historical false trigger events;
storing at least a portion of the central dataset to create a local dataset including at least a portion of the plurality of historical false trigger events;
receiving image data that represents one or more objects;
assigning a confidence score to each of the one or more objects based on comparing the one or more objects to the plurality of historical false trigger events stored in the local dataset, each confidence score representing a likelihood that a respective object of the one or more objects represents a current false trigger event;
in accordance with determining that the confidence score of each of the one or more objects is greater than a predetermined threshold:
updating the local dataset to include the one or more objects as one or more historical false trigger events; and
transmitting the updated local dataset to the computing device; and
in accordance with determining that at least one confidence score of the one or more objects is lower than the predetermined threshold, providing a security alert for display on one or more user devices.

Example 17. In this example, there is provided a non-transitory computer-readable memory of example 16, wherein the operations further comprise:
receiving, from at least one of the one or more user devices, a user input identifying the one or more objects as a current false trigger event;
updating the local dataset to include the one or more objects as one or more historical false trigger events; and
transmitting the local dataset to the computing device.

Example 18. In this example, there is provided a non-transitory computer-readable memory of example 16, wherein the one or more user devices comprise at least one of a home security gateway device, a mobile phone, and a personal computer.

Example 19. In this example, there is provided a non-transitory computer-readable memory of example 16, wherein the security alert includes at least a portion of the image data.

Example 20. In this example, there is provided a non-transitory computer-readable memory of example 16, wherein the one or more objects are identified in the image data by an image analysis tool.

Based on the disclosure and teachings provided herein, a person of ordinary skill in the art will appreciate other ways and/or methods to implement the various embodiments. The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method comprising:
receiving an event message from a home security edge device, the event message comprising image data;
determining whether the image data represents a false trigger event based on at least at one of:
inputting the image data into an artificial intelligence model; or
receiving a user input responsive to a presentation of the image data;
in accordance with determining that the image data represents the false trigger event:
generating training data for training the artificial intelligence model based on the false trigger event, the training data comprising the image data;
updating a local dataset to include the training data;
training the artificial intelligence model using the training data; and
transmitting the training data to a central database; and
in accordance with determining that the image data does not represent a false trigger event, providing a security alert for display on one or more user devices.

2. The method of claim 1, further comprising transmitting the training data to a central database.

3. The method of claim 1, wherein the home security edge device comprises at least one of a motion detector, a camera, and a microphone.

4. A computer-implemented method for determining a false trigger event, the computer-implemented method comprising:
receiving, from a computing device, a central dataset representing a plurality of historical false trigger events;
storing at least a portion of the central dataset to create a local dataset comprising at least a portion of the plurality of historical false trigger events;
receiving image data that represents one or more objects;
assigning a confidence score to each of the one or more objects based on comparing the one or more objects to the plurality of historical false trigger events stored in the local dataset, each confidence score representing a likelihood that a respective object of the one or more objects represents a current false trigger event;
in accordance with determining that the confidence score of each of the one or more objects is greater than a predetermined threshold:
updating the local dataset to include the one or more objects as one or more historical false trigger events; and
transmitting the updated local dataset to the computing device; and
in accordance with determining that at least one confidence score of the one or more objects is lower than the predetermined threshold, providing a security alert for display on one or more user devices.

5. The method of claim 4, wherein in accordance with determining that at least one confidence score of the one or more objects is lower than the predetermined threshold, providing the security alert for display on one or more user devices further comprises:
receiving, from at least one of the one or more user devices, a user input identifying the one or more objects as a current false trigger event;
updating the local dataset to include the one or more objects as one or more historical false trigger events; and
transmitting the local dataset to the computing device.

6. The method of claim 4, wherein the security alert comprises at least a portion of the image data.

7. The method of claim 4, wherein the central dataset is distributed to a plurality of home security gateway devices.

8. The method of claim 4, wherein the one or more user devices comprise at least one of a home security gateway device, a mobile phone, and a personal computer.

9. The method of claim 4, wherein the one or more objects are identified in the image data by an image analysis tool.

10. A system comprising:
a home security edge device; and
a home security gateway device comprising:
one or more processors; and
non-transitory computer-readable memory comprising instructions that when executed by the one or more processors, cause the home security gateway device to perform operations comprising:
receiving, from a computing device, a central dataset representing a plurality of historical false trigger events;
storing at least a portion of the central dataset to create a local dataset comprising at least a portion of the plurality of historical false trigger events;
receiving image data that represents one or more objects;
assigning a confidence score to each of the one or more objects based on comparing the one or more objects to the plurality of historical false trigger events stored in the local dataset, each confidence score representing a likelihood that a respective object of the one or more objects represents a current false trigger event;
in accordance with determining that the confidence score of each of the one or more objects is greater than a predetermined threshold:
updating the local dataset to include the one or more objects as one or more historical false trigger events; and
transmitting the updated local dataset to the computing device; and
in accordance with determining that at least one confidence score of the one or more objects is lower than the predetermined threshold, providing a security alert for display on one or more user devices.

11. The system of claim 10, wherein the operations further comprise:
receiving, from at least one of the one or more user devices, a user input identifying the one or more objects as a current false trigger event;
updating the local dataset to include the one or more objects as one or more historical false trigger events; and
transmitting the local dataset to the computing device.

12. The system of claim 10, wherein the security alert comprises at least a portion of the image data.

13. The system of claim 10, wherein the central dataset is distributed to a plurality of home security gateway devices.

14. The system of claim 10, wherein the one or more objects are identified in the image data by an image analysis tool.

15. The system of claim 10, wherein the home security edge device comprises at least one of a motion detector, a camera, and a microphone.

16. A non-transitory computer-readable memory comprising instructions that, when executed by one or more processors of a computer system, causes the computer system to perform operations comprising:
receiving, from a computing device, a central dataset representing a plurality of historical false trigger events;
storing at least a portion of the central dataset to create a local dataset comprising at least a portion of the plurality of historical false trigger events;
receiving image data that represents one or more objects;
assigning a confidence score to each of the one or more objects based on comparing the one or more objects to the plurality of historical false trigger events stored in the local dataset, each confidence score representing a likelihood that a respective object of the one or more objects represents a current false trigger event;
in accordance with determining that the confidence score of each of the one or more objects is greater than a predetermined threshold:
updating the local dataset to include the one or more objects as one or more historical false trigger events; and
transmitting the updated local dataset to the computing device; and
in accordance with determining that at least one confidence score of the one or more objects is lower than the predetermined threshold, providing a security alert for display on one or more user devices.

17. The non-transitory computer-readable memory of claim 16, wherein the operations further comprise:
receiving, from at least one of the one or more user devices, a user input identifying the one or more objects as a current false trigger event;
updating the local dataset to include the one or more objects as one or more historical false trigger events; and
transmitting the local dataset to the computing device.

18. The non-transitory computer-readable memory of claim 16, wherein the one or more user devices comprise at least one of a home security gateway device, a mobile phone, and a personal computer.

19. The non-transitory computer-readable memory of claim 16, wherein the security alert comprises at least a portion of the image data.

20. The non-transitory computer-readable memory of claim 16, wherein the one or more objects are identified in the image data by an image analysis tool.
